(19) United States
(12) Patent Application Publication
(10) Pub. No.: US 2010/0255906 A1
(43) Pub. Date: Oct. 7, 2010

(54) GRAPHICAL REPRESENTATION OF GAMING EXPERIENCE

(75) Inventor: Sheng-Wei Chen, Taipei (TW)

Correspondence Address: OCCHIUTI ROHLICEK & TSAO, LLP, 10 FAWCETT STREET, CAMBRIDGE, MA, 02138, US

(73) Assignee: Academia Sinica, Taipei (TW)

(21) Appl. No.: 12/568,782

(22) Filed: Sep. 29, 2009

Related U.S. Application Data
(60) Provisional application No. 61/166,507, filed on Apr. 3, 2009.

(51) Int. Cl. A63F 13/00; A63F 9/24

(52) U.S. Cl. 463/31; 463/43

(57) ABSTRACT

Some general aspects of the invention relate to approaches for generating a graphical representation of players' gaming experience. Gaming information representing player activity is first collected. The gaming information includes, for example, data obtained from a game log file characterizing a set of game events, and a set of images (e.g., comicshots associated with the game events) for use in generating the graphical representation. Images are associated with significance scores determined from at least the collected gaming information. Based on the significance scores, a set of images is selected for use in the graphical representation, and partitioned into subsets of images each subset to be presented in a respective one of one or more successive presentation units of the graphical representation. In some examples, the graphical representation can be enhanced by introducing textual annotations and/or sound effects to the images.

### CROSS-REFERENCE TO RELATED APPLICATIONS

This application claims the benefit of U.S. Provisional Application No. 61/166,507, titled “Graphical Representation of Gaming Experience” filed Apr. 3, 2009, the content of which is incorporated herein by reference.

### BACKGROUND

This application relates to systems and methods for generating graphical representation of gaming experience.

Online games are booming as they enable players to entertain and fulfill themselves in a virtual world. In a massive multiplayer online role playing game (MMORPG), players not only participate in the game but also share their gaming adventures with others via blogs and forums. Currently, video clips and screenshots are two types of media format commonly used by players to document their gaming experience. The video format, for example, is not only storage-consuming but may also require intensive editing effort to make it appealing to viewers. Screenshots, on the other hand, may not provide sufficient contextual information for the purpose of storytelling.

### SUMMARY

In this description, the term “screenshot” generally refers to a stored representation of an image that is displayed on a visual output device during a game; the phrase “game significant shot” (or simply “sigshot”) generally refers to a stored representation of an image that may be rendered by a graphical rendering engine of a computing system even if such image is not displayed on a visual output device during a game; the term “comicshot” generally encompasses both screenshots and sigshots.

Some general aspects of the invention relate to approaches for generating a graphical representation of players' gaming experience. Gaming information representing player activity is first obtained. The gaming information includes, for example, data obtained from a game log file characterizing a set of game events, and a set of images (e.g., comicshots associated with the game events) for use in generating the graphical representation. Images are associated with significance scores determined from at least the collected gaming information. Based on the significance scores, a set of images is selected for use in the graphical representation, and partitioned into subsets of images each subset to be presented in a respective one of one or more successive presentation units of the graphical representation. In some examples, the graphical representation can be enhanced by introducing textual annotations and/or sound effects to the images. The textual annotations can be determined from the collected gaming information and/or additional information provided by a player.

In some examples, the graphical representation takes a form substantially similar to a printed comic book.

In some embodiments, the approaches can be implemented in a system that analyzes the log and comicshots of a game play and generates comics of the play in a fully automatic manner. In some embodiments, the system also provides a user-interface that allows users to customize their own comics. As a result, users can easily use the system to share their stories and create individual comics for archival purposes or storytelling.

Advantages of the approaches may include one or more of the following.

Gaming experience can be shared by different game players over the Internet. The graphical representation of gaming experience can be used as a form for players' in-game journal, allowing them to review their adventures any time. The sharing of gaming experience can also provide an assistance platform for strategy guide writing.

Other features and advantages of the invention are apparent from the following description, and from the claims.

### DESCRIPTION OF DRAWINGS

FIG. 1 is a block diagram of one embodiment of a comic generation engine.

FIG. 2 illustrates a layout computation method.

FIG. 3 illustrates an image rendering method.

FIG. 4 illustrates a user interface of a comic generation engine.

FIG. 5 illustrates an interface through which users can edit images.

FIG. 6 illustrates one example of a comic book page created by the comic generation engine of FIG. 1.

### DETAILED DESCRIPTION

### 1 Comic Generation System

Online games have gained increasing popularity among players over the recent years. It has also become common for players to share their gaming experience and adventures on the Internet. For instance, a player may describe the kind of monsters he encountered and the kind of missions he solved during a particular game session. As previously mentioned, some of the existing forms of experience-sharing can be time-consuming (e.g., if it involves article writing or video editing) as well as resource intensive (e.g., if videos need to be stored).

The following description provides discussion of approaches for generating graphical representations of players' gaming experience, for example, in a form similar to a comic book. Using some of the approaches, narrative cartoon comics are generated in a fully automatic manner without modifying a particular game's core engine. Also, interactive editing functions are provided for players to generate personalized comics based on their preferences and interests.

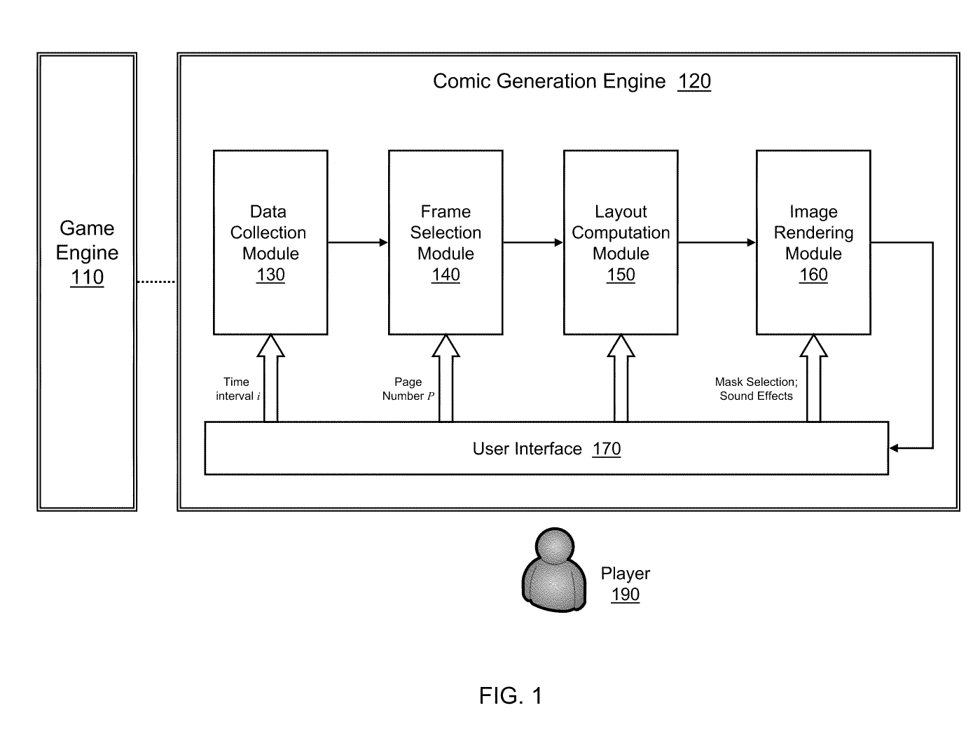

Referring to FIG. 1, one embodiment of a comic generation engine 120 is configured to create graphical representations of a player's gaming activities for storytelling. Very generally, the comic generation engine 120 obtains data including comicshots characterizing a player's actions and encounters during game play, and then realigns selected comicshots into comic strips to provide viewers narration of the game story in a condensed and pleasing format.

In this embodiment, the comic generation engine 120 includes a data collection module 130, a frame selection module 140, a layout computation module 150, and an image rendering module 160. These modules, as described in detail below, make use of data representative of a player's game interactions with a game engine 110 to create cartoon comics in a desired presentation to be shared by various players. The comic generation engine 120 also includes a user interface 170 that accepts input from a player 190 to control parameters used in the comic generation process to reflect player preferences.

### 1.1 Data Collection

In some embodiments, the data collection module 130 is configured to accept data characterizing player activities (e.g., a log file of game events and comicshots from the game). Many online games now provide mechanisms to monitor changes in a player's status and actions, and record game events and screenshots considered to be important during game play. For instance, status changes and interactions such as chatting, combat, looting, zone changes, experience point changes, and trade between players, may be regarded as potentially significant events and are therefore recorded. In some embodiments of the present invention, the game engine 110 automatically creates a log file and captures comicshots at a predefined time interval i and/or upon occurrence of a potentially significant event. Such data can be saved in a data storage that is accessible by the data collection module 130 for retrieval. The log file can include descriptive information of the captured comicshots, for instance, the timestamp of a comicshot, the game events associated with the comicshot, and chat messages and combat logs that occurred between the time the comicshot was obtained and the last time a comicshot was obtained. The log file can also include global parameters such as a set of significance scores. Generally, each significance score of the set is associated with an event type, and the significance score for an event type indicates the importance of this event in the game.

In some examples, the data collection module 130 is able to interact with the game engine 110 to configure, for example, the conditions under which comicshots are obtained. For instance, the data collection module 130 may allow a player 190 to set the frequency of data collection via the user interface 170 based on his preferences (e.g., how specific he wants to be when recording and editing game sessions), and to specify the types of events that he considers as potentially significant. Such configuration data is provided to the game engine 110 to modify the way by which data is recorded. The data collection module 130 may also record a scene of the game world from a perspective other than that of the game player (e.g., a bird view from the top or a close-up view of a character's face). In other examples, if a player finds a precious virtual item, the data collection module 130 may be directed (e.g., through user input) to take close-ups of the item for use in emphasizing the look of the virtual item in a subsequently-generated comics. The close-ups may be screenshots, sigshots, or some combination of both. Likewise, the comicshots can be taken at different locations in the game virtual world other than the game character's current position. For example, when a game character toggles a certain switch that opens a gate elsewhere, the data collection module 130 interacts with the game engine 110 to render a shot for the opening gate for storytelling purposes.

### 1.2 Frame Selection

To produce a concise summary of gaming experience, the frame selection module 140 determines comicshot images to be used for comic generation, for instance, according to a determined importance or significance. In some examples, the total number of pages N_{page} of the comics can be specified by the player 190. In one embodiment, when the player 190 assigns the number of pages N_{page} and initiates the comic generation process, the frame selection module 140 makes three decisions as follows. First, it estimates the total number N_{image} of images needed for the desired comics. Second, it determines significance score(s) for each of the comicshot images recorded. Third, it ranks the comicshot images in descending order by their significance scores and selects the top ranked N_{image} number of images to be used in the comics.

More specifically, one approach to estimate the number of images needed for the user-defined N_{page} pages introduces a randomly generated variable N_{IPP} (defining the number of images per page) into the estimation process. For example, given the number of pages N_{page}, the total number of images N_{image} to appear in the comics can be calculated by N_{image}=N_{page}·N_{IPP}. In some examples, N_{IPP} is selected to follow a normal distribution with a mean equal to 5 and a standard deviation equal to 1 in order to improve the appearance of the comic layout. The player 190 can change the number of images in a comic by simply clicking a “Random” button through the user interface to reset the value of N_{IPP} at any time.

In some examples, to determine the significance score(s) of an image, let S_{image} represent an image's significance score and N_{type} be the number of event types present in a recorded comicshot image. For a particular event type k, let cₖ denote its frequency of occurrence, and wₖ be the specified weight characterizing a degree of importance for this event type k. The values of the weights can be initially assigned by default and later changed by the player 190. The significance score(s) of an image occurring at timestamp t can be calculated as a weighted sum of the significance of the various types of events with which this image is associated, as shown below:

$${S}_{image} = {\sum }_{1}^{{N}_{type}} {c}_{k} \cdot {w}_{k}$$

In one embodiment, using this equation, each image is assigned a corresponding score S_{image}, based on which the images can be ranked in descending order.

In some examples, the significance score of an image is computed by aggregating the scores of the events associated with the image. Generally each event may itself be associated with a score computed based on two contributing components, namely a predefined component and a variable component. For example, the score associated with a “kill a monster” event may be the sum of a 5-point predefined score applicable for any and all “kill a monster” events, and a 1- to 3-point variable score selected based on the type of monster that is killed (e.g., if the character kills a rabbit (worth a 1-point variable score), the score associated with this particular “kill a monster” event is 6 (where 5 of the 6 points come from the predefined component, and 1 of the 6 points comes from the variable component); if the character kills a demon (worth a 3-point variable score), the score associated with this particular “kill a monster” event is 8 (where 5 of the 8 points come from the predefined component, and 3 of the 8 points comes from the variable component).

Finally, the highest ranked N_{image} images are selected from the pool of comicshot images to be used for comic generation.

### 1.3 Layout Computation

Once the most significant images are selected, the layout computation module 140 determines how to place these images onto the N_{page} as follows. First, images are partitioned into groups, with each group being placed on the same page. Second, graphical attributes (e.g., shape, size) of the various images on the same page are determined based on their significance scores.

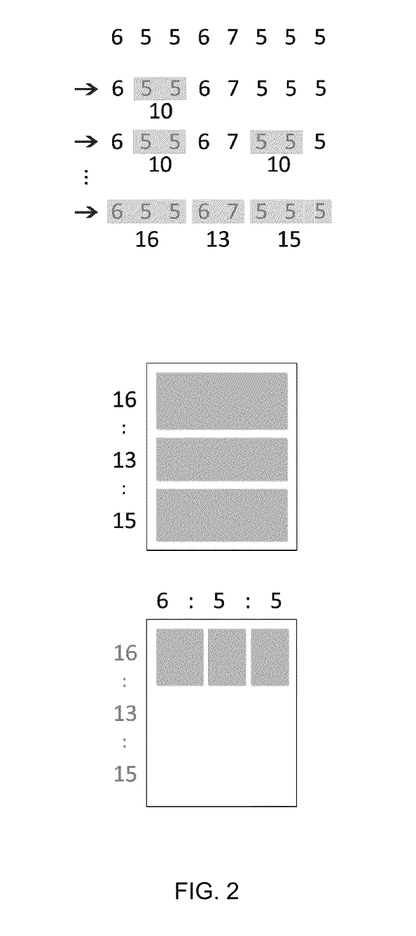

Referring to FIG. 2, one process to partition the images into groups is shown. Here, the number of groups is selected to be equal to the number of pages specified by the player 190. Initially, the selected images are divided into page groups based on their significance scores in a chronological order. In this example, 8 images whose significance scores are respectively 6, 5, 5, 6, 7, 5, 5, 5 are selected to be on the same page. These images are then arranged into several rows based on the scores. Once a page has been generated, the image set of the page, the positions, and the sizes of the images on the page are fixed.

Since the presentation of each comic page is laid out in a 2D space, images that have been grouped on one page are placed into blocks in either column or row order. In this particular example, images are placed in rows according to their chronological order and the number of images in a row depends on the significance scores. In one example, neighboring images having the lowest sum of scores are grouped into a row.

In some examples, a region is defined as referring to an image's shape and size on a page. To create variety and visual richness, regions can be randomly reshaped with slants on their edges so that the images look appealing on the comic pages. After the placements of the selected images are determined, the dimensions and regions of the images are calculated based on their significance scores. For instance, images with higher significance scores are assigned with larger areas on a page; conversely, less significant images cover smaller areas.

### 1.4 Image Rendering

In some embodiments, to create the appearance and feeling of a comic book, the image rendering module 160 uses a three-layer scheme to render an image on a page. The three layers include the image, the mask of the image, and word balloons and sound effects (if any).

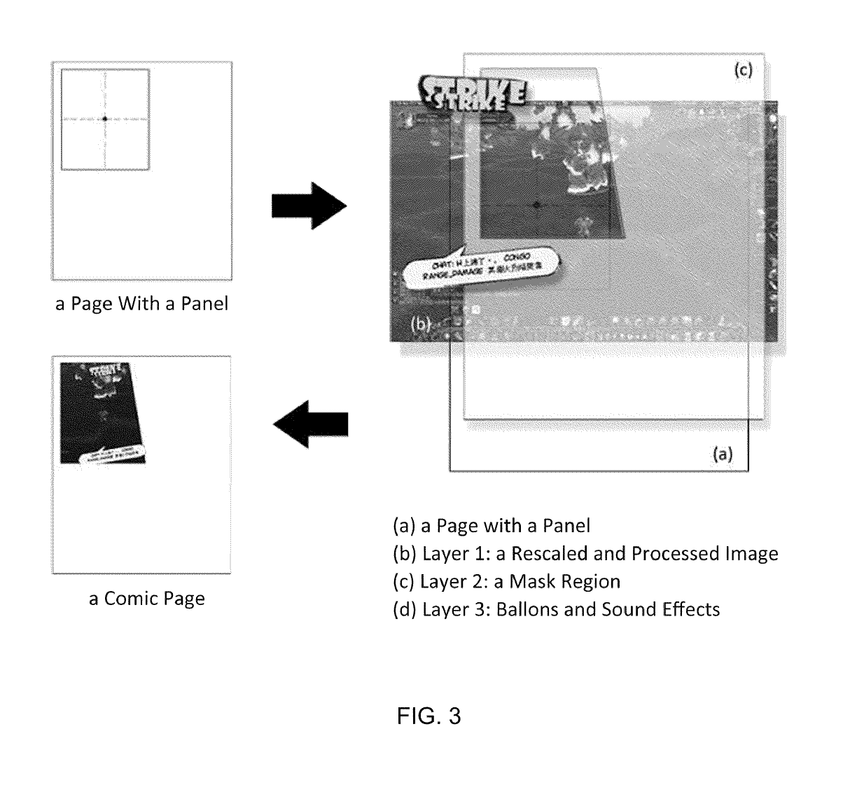

FIG. 3 shows one example of the three-layer scheme. Here, an image is processed as the bottom layer and placed on a panel, which is the area where the image is to be placed on the comic page. Edge detection techniques and cartoon-like filters are applied to the image to emulate a comic style. The image is then resized to fit the region and drawn with its center aligned on the panel. Next, a mask layer is placed over the bottom layer to crop an image's region; that is, any drawing outside the region is ignored. Finally, embellishments such as word balloons and sound effects are placed on the top layer to enrich expressions in the comic's text. In particular, with edge detection techniques, the image rendering module can select to put the word balloons at locations where no main characters are placed.

Once image rendering is completed, the comic generation engine 120 forms a data representation of a comic book having a set of one or more pages, with each page including selected images representing the player's gaming activities. The comic generation engine 120 may store the data representation in electronic forms, for example, as a multimedia file such as JPEG, PNG, GIF, FLASH, MPEG, PDF files, which can be viewed and shared later among various players.

### 2 Examples

For purposes of illustration, the above-described comic generation techniques are applied to create comics for World of Warcraft (WoW), one of the most prevalent massive multiplayer online role playing games (MMORPG) worldwide. According to a report published by Blizzard—the company that created WoW, this game has over 11.5 million players many of whom tend to share their gaming experiences with each other in both real life and virtual communities. For instance, stories such as record breaking events or the victory of a team of players over an entrenched arch enemy are often posted on weblogs.

The WoW game engine provides a comprehensive game log scheme. Blizzard publishes a set of game APIs that allow users to record every game event through a WoW Add-on component. Therefore, the comic generation engine 120 can make use of a WoW Add-on to script game events and screenshots desired for comic generation without modifying the WoW core engine.

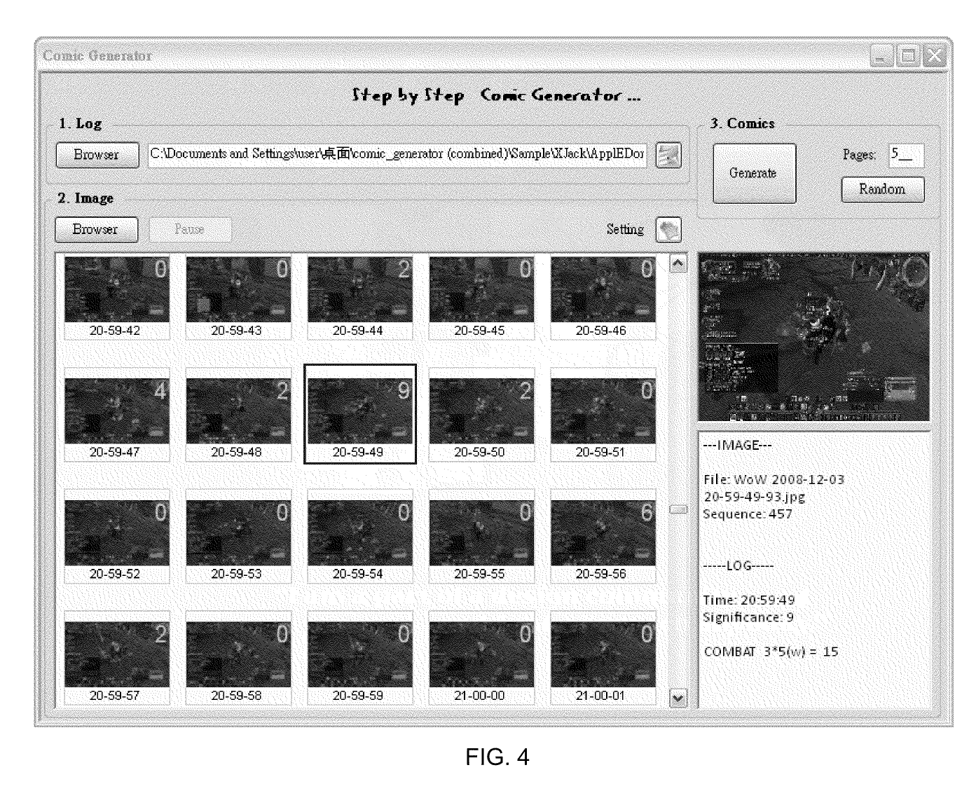

FIG. 4 shows an exemplary user interface by which a user (e.g., a player) can create comics of his WoW game events. Here, a player's interactions with the game are archived as data in a log file and comicshot images (e.g., stored in a computer directory). The user can load the log file by clicking on the “Browser” button in the Log section of the interface. For example, the user can open the original log file and make edits to the file. The user can also load the comicshot images by clicking on the “Browser” button in the Image section of the interface. Thumbnail images of all (or user-selected) comicshots are then provided in a viewing panel of the Image section. The significance score (if available) of an image is also shown at the right top corner of the image. Note that in some examples, the log file is optional. If a user does not have a log file, the comic generation engine will randomly assign a significance score for each image and render comic pages without text.

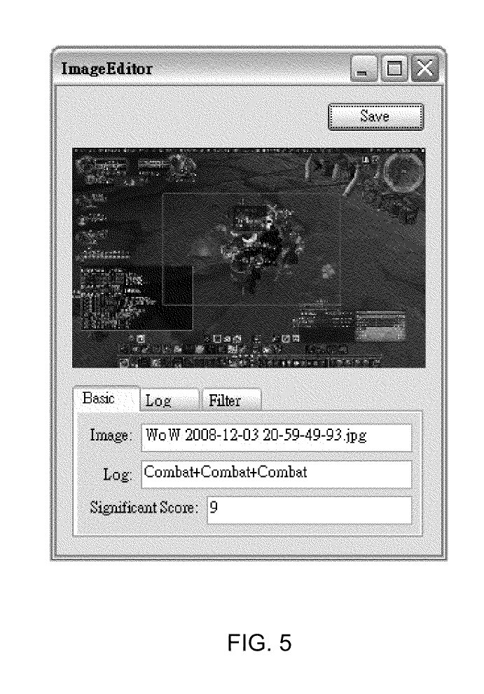

FIG. 5 shows an example of an ImageEditor panel that allows the user to edit a particular image by double-clicking on the image shown in the Image section of FIG. 4. Through the ImageEditor, the user can modify the log information and the significance score, and apply filters to the image.

Referring back to FIG. 4, once the log file and comicshot images are loaded into the interface, the user enters the total number of pages to appear in this comic (in the example, 5 pages), and hits the “Generate” button. The comic generation engine then determines the most significant images to include in the 5 pages, the layout of these images, and visual characteristics of these images to appear in the final product.

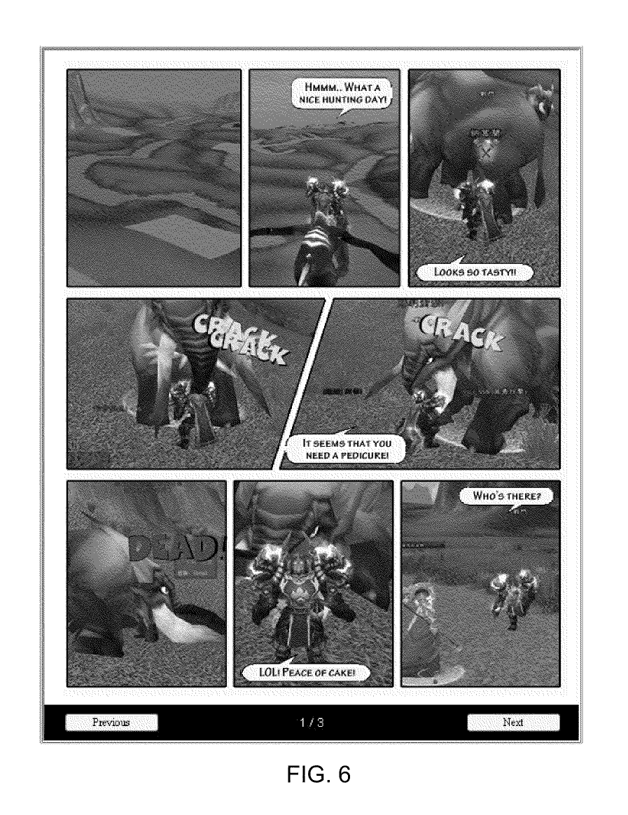

FIG. 6 shows one example of a WoW comic page created by the comic generation engine 120 of FIG. 1. On this page, 8 images are displayed in 3 rows to provide a partial summary of a WoW player's game play. This example also illustrates the diversity of region sizes and visual richness, such as the slants on edges of the regions. The comic generation engine 120 also retrieved chat messages and combat logs (e.g., from the log file) that occurred while the game's comicshots were being recorded. These chat messages are displayed here in word balloons. Sound effects of combat are also added to make the comics more interesting.

Various computational and graphical design techniques can be used in the comic generation process to enhance the appearance of the comics. For example, object detection techniques can be used to pinpoint the location and size of game characters in comicshots so that the comic generation engine can crop comic book frames and put word balloons on frames accurately. Also, the layout computation algorithm can be modified to make the generated comics more similar to hand-drawn publications. Further, the user interface can be refined by introducing additional editing features to meet user needs, thereby creating a more user-friendly platform for experience sharing and storytelling among players in the virtual community.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

It is to be understood that the foregoing description is intended to illustrate and not to limit the scope of the invention, which is defined by the scope of the appended claims. Other embodiments are within the scope of the following claims.

What is claimed is:

1. A computer-implemented method comprising:
obtaining, from a machine-readable data storage, data including a plurality of images representative of a player's in-game activities; and
generating a graphical representation of the in-game activities based on the obtained data, including:
for each one of the plurality of images, determining at least one score characterizing a degree of significance of the image;
selecting, from the plurality of images, a set of images to be presented in the graphical representation based at least on the determined scores;
partitioning the selected set of images into subsets of images each subset to be presented in a respective one of one or more successive presentation units of the graphical representation; and
for each subset of images to be presented in a corresponding presentation unit of the graphical representation, determining visual characteristics based at least on the determined scores associated with the images.

2. The computer-implemented method of claim 1, wherein the data obtained from the machine-readable data storage includes descriptive information of the plurality of images.

3. The computer-implemented method of claim 2, wherein the descriptive information of the plurality of images includes a specification of an association of the in-game activities represented by an image with one or more events.

4. The computer-implemented method of claim 3, wherein each event is characterized by an event type, and each event type is associated with a significance score.

5. The computer-implemented method of claim 4, wherein determining the at least one score characterizing a degree of significance of the image includes:
identifying one or more event types associated with the image based on the descriptive information; and
computing the score of the image based at least in part on the significance scores of the identified one or more event types.

6. The computer-implemented method of claim 5, wherein computing the score of the image includes:
aggregating the significance scores of the identified one or more event types.

7. The computer-implemented method of claim 4, wherein each event type is associated with a significance score that is characterized by a predefined component, a variable component, or both.

8. The computer-implemented method of claim 1, wherein selecting the set of images to be presented in the graphical representation includes:
determining the number of images in the selected set based on user input; and
selecting the determined number of images according to the scores of the images.

9. The computer-implemented method of claim 1, wherein partitioning the selected set of images into subsets of images includes:
for each subunit of the graphical representation, determining a layout of the corresponding subset of images.

10. The computer-implement method of claim 9, wherein the layout of the subset of images includes row or column positions of the images.

11. The computer-implemented method of claim 1, determining visual characteristics includes:
associating an image with at least one textual description of the in-game activities represented by the image.

12. The computer-implemented method of claim 1, determining visual characteristics includes:
associating an image with at least one sound effect based on the in-game activities represented by the image.

13. The computer-implemented method of claim 1, wherein the visual characteristics of an image includes a size of the image.

14. The computer-implemented method of claim 1, wherein the visual characteristics of an image includes a shape of the image.

15. The computer-implemented method of claim 1, wherein the generated graphical representation of the in-game activities includes a comic book style representation.

16. The computer-implemented method of claim 15, wherein each presentation unit of the graphical representation includes a page.

17. The computer-implemented method of claim 1, further comprising:
forming a data representation of the graphical representation of the in-game activities.

18. A system comprising:
an input data module for obtaining, from a machine-readable data storage, data including a plurality of images representative of a player's in-game activities; and
a processor for generating a graphical representation of the in-game activities based on the obtained data, the processor being configured for:
for each one of the plurality of images, determining at least one score characterizing a degree of significance of the image;
selecting, from the plurality of images, a set of images to be presented in the graphical representation based at least on the determined scores;
partitioning the selected set of images into subsets of images each subset to be presented in a respective one of one or more successive presentation units of the graphical representation; and
for each subset of images to be presented in a corresponding presentation unit of the graphical representation, determining visual characteristics based at least on the determined scores associated with the images.

19. The system of claim 18, further comprising an interface for accepting user input associated with a selection of images.

20. The system of claim 19, wherein the user input includes a specified number of successive presentation units of the graphical representation.

21. The system of claim 19, wherein the interface is further configured for accepting user edits to one or more images.

22. The system of claim 18, wherein the generated graphical representation of the in-game activities includes a comic book style representation.

23. The system of claim 18, wherein the system further includes an output module for forming a data representation of the graphical representation of the in-game activities.

24. The system of claim 23, wherein the data representation includes a multimedia representation.

25. The system of claim 24, wherein the multimedia representation includes one or more of a JPEG file, a PNG file, a GIF file, a PDF file, a MPEG file, and a FLASH file.
